(19) United States
(12) Patent Application Publication
(10) Pub. No.: US 2024/0016688 A1
(43) Pub. Date: Jan. 18, 2024

(54) OPERATING TABLE HAVING A LOAD SENSOR ARRANGEMENT

(71) Applicant: MAQUET GMBH, Rastatt (DE)

(72) Inventors: Rodrigo Del Alcazar von Buchwald, Waldbronn (DE); Achim Schäfer, Iffezheim (DE); Tim Golde, Weingarten (DE); Immanuel Gaiser, Weisenbach (DE); Jan Donat Olszewski, Rastatt (DE); Mike Obert, Gernsbach (DE)

(73) Assignee: MAQUET GMBH, Rastatt (DE)

(21) Appl. No.: 18/477,075

(22) Filed: Sep. 28, 2023

Related U.S. Application Data
(63) Continuation of application No. PCT/EP2022/050443, filed on Jan. 11, 2022.

(30) Foreign Application Priority Data
Mar. 29, 2021 (DE) 102021107833.4

(51) Int. Cl. A61G 13/08; A61G 13/12

(52) U.S. Cl. CPC A61G 13/08; A61G 13/129; A61G 2203/32; A61G 2203/44; A61G 2203/70

(57) ABSTRACT

Operating table (100) comprising a load sensor assembly (102) having multiple load sensors for measuring at least one variable from which a load acting on the load sensor assembly (102) can be determined, wherein the load sensor assembly (102) is arranged between at least two parts of the operating table (100), and wherein the at least two parts are substantially non movable in relation to one another. The load sensors may be arranged in a shared common plane. Output from the sensors can be used to prevent tipping or overloading of the operating table or portions of the operating table.

### CROSS-REFERENCE TO RELATED APPLICATIONS

The present application claims priority and is a continuation of international patent application no. PCT/EP2022/050443 filed Jan. 11, 2022, which claims the priority of German patent application No. 10 2021 107 833.4, which was filed with the German Patent and Trademark Office on 29 Mar. 2021. The disclosure contents of international application no. PCT/EP2022/050443 and of German patent application No. 10 2021 107 833.4 are hereby incorporated into the disclosure content of the present application.

### TECHNICAL AREA

The present disclosure relates to an operating table having a load sensor assembly.

### BACKGROUND OF THE DISCLOSURE Operating tables are used to position a patient, for example during a surgical procedure.

Currently, due to the flexibility in the setup of the operating table, the number of accessories, and the various options for patient positioning that the operating table offers, nurses and physicians have to consider many important aspects in order to use the operating table properly. Some of these aspects are listed below:
The accessories used are to be matched to the patient's weight.
The configuration of the accessories is also to be matched to the patient's weight.
The patient support surface on which the patient is located is only to be moved within permitted limits.
If a movement restriction applies, care is to be taken not to exceed the permitted limits at any time.
When adjusting the operating table, care is to be taken that the operating table does not collide with an external object, such as a C-arm.
Furthermore, when adjusting the operating table, care is to be taken to ensure that the patient is correctly secured and does not fall or slip off the operating table.

Important information on the points listed above can be found in the instructions for use of the operating table. If the user ignores the instructions for use or does not pay enough attention to collisions and the patient, the following dangerous events can occur:

Tipping over of the operating table: Fall of the patient, which can result in permanent injuries and even death. Overloading structural parts of the accessories and the operating table: This can have the result

that structural parts permanently bend or break, causing permanent injury or even death to the patient.

Overloading the motorized joints: Causes restricted mobility as the operating table cannot move.

Collision of the operating table with an external object: During the movement, the operating table can collide and damage expensive equipment, such as C-arms.

Falling of the patient: If the patient is not adequately secured, the patient can start to slip when the table moves, which in the worst case can result in the patient falling to the floor.

### SUMMARY OF THE DISCLOSURE

It is an object of the present disclosure to provide an operating table having a load sensor assembly, wherein the load sensor assembly is advantageously designed to measure a variable, from which a load acting on the load sensor assembly can be determined.

Another object of the present disclosure is to provide an operating table that generates a signal indicating a risk of the operating table tipping over.

Yet another object of the present disclosure is to provide an operating table that generates a signal indicating a risk of overloading the operating table and/or a component of the operating table.

According to a first aspect of the present disclosure, an operating table comprises a load sensor assembly having multiple load sensors. The load sensor assembly is designed to measure at least one variable, i.e., precisely one or more variables, from which a load acting on the load sensor assembly can be determined.

The load acting on the load sensor assembly can in particular include all external force variables, i.e., forces and moments, which act on the load sensor assembly. The load sensors can be, for example, force sensors, in particular load cells, which each measure a force acting on the respective sensor. In such a configuration, the measured variable can be the force measured by each of the force sensors, i.e., each of the force sensors measures a corresponding variable. The force sensors can each emit an electrical signal, for example an electrical voltage, as an output signal, from which the force measured in each case can be derived. Furthermore, it can also be provided that the force sensors each output the specific variable of the force measured by them, for example in digital form.

It is also conceivable that the load sensor assembly measures a resulting total force as a variable, wherein the resulting total force is obtained from the individual forces acting on the different force sensors. In this case, the load sensor assembly can, in particular, measure precisely one variable, namely the resulting total force. The total force can again be output as an electrical signal, for example as an electrical voltage, from which the force measured in each case can be derived, or as a specific variable, for example in digital form.

The load acting on the load sensor assembly comprises, for example, the load caused by the components of the operating table arranged above the load sensor assembly as well as the load caused by the patient supported on the operating table or other objects located on the operating table. Furthermore, a person can also cause a load on the operating table, for example by the person standing next to the operating table and supporting himself on the operating table with a hand or another part of the body. Additionally, external forces generated in another way may generate a load on the operating table. Such loads can also be measured by the load sensor assembly.

The load sensor assembly having the multiple load sensors is arranged between at least two parts of the operating table. The at least two parts are essentially not movable in relation to one another. If the operating table, in particular the patient support surface, is moved or adjusted during operation, for example, when tipping and/or extending the patient support surface, the at least two parts essentially do not move in relation to one another, i.e., they remain essentially in the same position in relation to one another. This applies both to the distance of the at least two parts from one another and to the angle or angles that the at least two parts form with one another.

However, the at least two parts can move very slightly relative to each other to the extent that the load sensors are physically deformed by weight and pressure. Thus, “essentially the same position” includes a relative movement of at least two parts by up to 3 millimeters due to a temporary deformation of the load sensors. In an alternative formulation, one could say that the multiple load sensors or the at least two parts are only movable relative to one another by a maximum of 3 millimeters, and/or they are only movable to the extent that the load sensors are physically deformed.

The at least two parts of the operating table can be arranged directly next to or adjacent to the load sensor assembly. The load sensor assembly can be in contact with the two parts. For example, the load sensor assembly can touch each of the two parts. At least during operation of the operating table, the two parts can be firmly connected to the load sensor assembly.

The load sensor assembly can be arranged at different positions in the operating table. For example, the load sensor assembly can be integrated into the column of the operating table. In this case, a first side of the load sensor assembly can be connected to at least one first part of the column, and a second side of the load sensor assembly, which can in particular be opposite to the first side, can be connected to a second part of the column. The first and the second part of the column are designed such that they are not movable in relation to one another. Furthermore, the first part of the column can be arranged above the second part of the column.

Furthermore, the load sensor assembly can be arranged at or adjacent to interfaces which the column forms with the patient support surface or the stand (or base). Consequently, the load sensor assembly can be arranged, for example, between the patient support surface and the column. In this case, the first side of the load sensor assembly can be connected to a part of the patient support surface and the second side of the load sensor assembly can be connected to a part of the column, wherein the two parts are not movable in relation to one another.

Alternatively, the load sensor assembly can be arranged, for example, between the column and the stand. In this case, the first side of the load sensor assembly can be connected to a part of the patient support surface and the second side of the load sensor assembly can be connected to a part of the stand, wherein the two parts are not movable in relation to one another.

The integration of the load sensors between two or more non-moving structural parts of the operating table has several advantages over other solutions, in particular solutions in which the load sensors are integrated in joints. For example, it is conceivable that in such solutions, the load sensors are integrated into multiple universal joints such that the load sensors are each located between multiple, for example three parts movable in relation to one another. Such a solution is not ideal since dynamic effects result in large accuracy problems. Also, moving parts tend to wear out over time, making the system less reliable and requiring constant maintenance and calibration. Such problems are reduced or even eliminated by placing the load sensors between at least two structurally non-moving parts.

The load sensor assembly can be integrated into the operating table such that the entire load flows or is transferred through the load sensor assembly. In particular, that load can flow through the load sensor assembly or be transmitted through it which is caused above the load sensor assembly.

In one embodiment, the load sensors of the load sensor assembly can be arranged parallel and in a mirror image in relation to one another. For example, the load sensor assembly can have a total of four force sensors or load cells. This embodiment has the advantage of increased accuracy and reliability.

Several or all of the load sensors of the load sensor assembly can be arranged mirror-symmetrically with respect to a first imaginary axis and minor-symmetrically with respect to a second imaginary axis. The first and the second axis can be aligned orthogonally to one another. The first axis can, for example, extend parallel to a main axis of the patient support surface, while the second axis extends perpendicular to this main axis but parallel to the patient support surface. In this case, the load sensor assembly can be arranged between the patient support surface and the operating table column.

In some designs, the load sensors are arranged in a grid pattern or grid having a plurality of load sensors on each “side”. In some embodiments, all load sensors are arranged in a common plane. For example, the load sensors can be arranged in a 2×2 grid. For example, the load sensors can be arranged in a grid arrangement having 2 to 4 load sensors in each dimension.

The mirror-symmetrically arranged load sensors can be aligned in the same direction. In particular, the mirror-symmetrically arranged load sensors can be aligned parallel to one another. The load sensors can each have a main axis, which are aligned parallel to one another.

The load sensors of the load sensor assembly can be structurally identical.

In some embodiments, the load sensors have an elongated shape. For example, the load sensors can be rectangular bodies.

In one embodiment, the operating table can have a load determination unit. The load

determination unit can be coupled to the load sensor assembly and can receive the at least one measured variable from the load sensor assembly. Based on the at least one measured variable, the load sensor assembly can determine at least one of the following loads and/or one of the following centers of gravity:
a measurement load and/or the center of gravity of the measurement load;
an active load and/or the center of gravity of the active load; and
a total load and/or the center of gravity of the total load.

For example, the load sensor assembly can be designed such that it determines either all three of the above-mentioned loads and/or their centers of gravity, or a selection of two of the three above-mentioned loads and/or their centers of gravity, or only one of the above-mentioned loads and/or their centers of gravity.

The measurement load is the load that acts on the load sensor assembly. The measurement load corresponds to the load generated by all people, objects, and forces on the operating table above the load sensors. The measurement load corresponds to the load value measured by the load sensor assembly.

The active load corresponds to the load which is caused by components that are not associated with the operating table and people and external forces and which acts on the operating table. Components associated with the operating table are components recognized by the operating table, for example the main support surface section as well as secondary support surface sections fastened to the main support surface section and/or other accessories recognized by the operating table. The influence of the components associated with the operating table is not taken into consideration in the active load. Only the remaining components of the operating table contribute to the active load, i.e., the components not associated with the operating table. For example, these can be accessories that are not recognized by the operating table. Furthermore, the patient on the operating table contributes to the active load. All forces acting externally on the operating table, which are exerted on the operating table by people and/or objects outside the operating table, for example, also contribute to the active load.

The total load is that load which results from the measurement load and from a load caused by components which are associated with the operating table and are located below the load sensor assembly. The total load therefore takes into consideration loads from components that are located below the load sensor assembly and cannot be measured by the load sensor assembly and therefore do not contribute to the measurement load. The total load is therefore the load resulting from the entire operating table, the patient, the components associated with the operating table, the components not associated with the operating table, and other external forces.

In one embodiment, the operating table can furthermore have a safety unit which is coupled to the load determination unit and receives from the load determination unit at least one load value determined by the load determination unit and/or at least one center of gravity determined by the load determination unit. Based on the at least one load and/or the at least one center of gravity, the safety unit can generate a safety signal that indicates whether the operating table is in a safety-critical state. A safety-critical state exists, for example, when the safety of the patient on the operating table is endangered. For example, this can be the case when there is a risk that the operating table will tip over or be overloaded.

The safety unit can use other parameters to generate the safety signal, for example, position data of the operating table, which indicate the position in which the patient support surface in particular is located, information about recognized accessories, and the weight and center of gravity of the recognized accessories.

The safety unit makes it possible to warn the user of the operating table when a safety-critical condition occurs, in order to ensure the safety of the patient. Furthermore, measures can be taken to avert or prevent the safety-critical state.

In one embodiment, one or more measures can be taken if the safety unit generates the safety signal such that it indicates a safety-critical state of the operating table. For example, the operating table can generate an acoustic and/or visual warning signal. Furthermore, a warning signal can be generated in text form, which can be displayed to the user, for example, on a remote control of the operating table. In addition, the movement of the operating table can be restricted. For example, the extending and/or tipping of the patient support surface and/or the movement of the operating table can be slowed down or stopped. In addition, at least one functionality of the operating table can be blocked.

The measures taken can be reduced or canceled when the safety signal again indicates a safe state of the operating table.

In one embodiment, the safety unit can have a tipping prevention unit which, based on the total load and/or the center of gravity of the total load, generates a tipping safety signal which indicates whether there is a risk of the operating table tipping over. The tipping safety signal is therefore a safety signal from the safety unit.

If there is a risk of tipping, for example, acoustic and/or visual warnings can be generated to the user and/or measures can be taken to prevent the operating table from tipping. For example, movements of the operating table can be blocked or the speed of the operating table can be reduced.

In one embodiment, the tipping prevention unit can determine a residual tipping torque for at least one tipping point based on the total load and/or the center of gravity of the total load. Furthermore, the tipping prevention unit compares the determined residual tipping torque to a predetermined residual tipping torque threshold value and generates the tipping safety signal such that it indicates a risk of tipping if the residual tipping torque falls below the residual tipping torque threshold value.

A tipping point is a point or, if applicable, an axis around which the operating table can tip. For example, a tipping point can be located on a lower side edge of the stand that faces toward the floor. Furthermore, a tipping point can be characterized by a roller, using which the operating table can be displaced on the floor.

In some embodiments, the tipping points can be defined as all points along the perimeter of a table base or stand that faces toward (and in some cases touches) the underlying floor. For example, all points along the perimeter of a rectangular table base can be tipping points. In other configurations, for example, when the foot has a less regular shape, the tipping points can be defined as all points along the edges of a conceptual or imaginary polygon defined by the far corners of a stand. For example, in the case of an H-shaped base, the tipping points would be the four corners of the H and the edges of a conceptual rectangle formed by the four corners of the H. With a round base, any point on the circumference would be a tipping point.

In general, it can be said that the operating table remains stable when the center of gravity of the total load is above an area bounded by the tipping points. However, if the center of gravity of the total load is not directly above this area, the operating table will tip over.

The residual tipping torque at a tipping point can be determined by multiplying the distance of the tipping point from the center of gravity of the total load by the total load, wherein the total load is expressed as a force. The residual tipping torque is referred to in the English-language technical literature as the “residual tipping torque”. If the determined value for the residual tipping torque is positive, this means that the operating table is stable with respect to this tipping point. If the residual tipping torque is negative, the operating table will tip over. The greater the value of the residual tipping torque, the more stable the operating table. In this embodiment, the residual tipping torque threshold value is specified, which has a value of 225 Nm, for example. This means that the residual tipping torque is not to be less than 225 Nm. If the residual tipping torque threshold value is not reached, the operating table can warn the user acoustically or visually. Other possibilities are blocking movements or reducing the speed of the operating table.

In one embodiment, the tipping prevention unit can determine a respective residual tipping torque for a plurality of tipping points, in particular for all possible tipping points. The tipping prevention unit can compare each of these multiple residual tipping torques to the residual tipping torque threshold value. If only one of the tipping torques falls below the residual tipping torque threshold value, the tipping prevention unit can generate the tipping safety signal such that it indicates a risk of tipping. This creates a high level of security with regard to the tipping of the operating table.

In one embodiment, at least one virtual or imaginary line can be specified, which extends through at least one tipping point and which encloses a specified angle, a so-called stability angle, with a specified normal vector, wherein the tipping prevention unit generates the tipping safety signal such that it indicates a risk of tipping if the center of gravity of the total load extends through the at least one virtual line. In particular, the tipping safety signal can indicate a risk of tipping when the center of gravity of the total load extends through the at least one virtual line in a direction in which the residual tipping torque decreases. This embodiment also includes the case in which the virtual line is shifted in parallel and accordingly does not extend through the tipping point. In this case, the center of gravity of the total load also has to be shifted accordingly in order to be able to indicate the risk of tipping.

The normal vector can be defined, for example, by the vector of the weight of the operating table when the operating table is on a flat, non-sloping floor. Then the normal vector is aligned perpendicular to the floor surface. The normal vector can also be defined, for example, by the base plate of the stand or the patient support surface in the normal position. Then the normal vector is aligned perpendicular to the base plate of the stand or perpendicular to the patient support surface in the normal position.

In one embodiment, at least one virtual or imaginary line can be specified for a plurality of tipping points, in particular for all possible tipping points, which extends through the respective tipping point and encloses a specified angle, a so-called stability angle, with the specified normal vector. The multiple virtual lines define a space. As long as the center of gravity of the total load is within this space, there is no risk of the operating table tipping over. Only when the center of gravity of the total load leaves the space defined or delimited by the virtual lines can the operating table tip over. The tipping prevention unit therefore generates the tipping safety signal such that it indicates a risk of tipping if the center of gravity of the total load leaves the space defined by the virtual lines.

In one embodiment, the predefined stability angle, which the virtual or imaginary line through a tipping point encloses with the specified normal vector, can depend on the nature of the tipping point. For example, the stability angle can be larger if the tipping point is given by a roller. In comparison, the stability angle can be smaller if the tipping point does not include a roller but is located, for example, on a lower side edge of the stand.

In one embodiment, a stability angle of 10 degrees can be chosen if the tipping point is given by a roller. For all other tipping points, especially rigid bases or substructures, a stability angle of 5 degrees can be selected.

In some embodiments, the stability angle is at least 2 or at least 5 degrees, or is in the range of 5 to 15 degrees, or in the range of 3 to 20 degrees. In some embodiments with retractable wheels or rollers, the stability angle is at least 2 degrees when the operating table is on the floor and at least 8 degrees when it is on wheels or rollers. Certain safety regulations require that medical tables remain stable at an inclination of 5 degrees when standing directly on the floor and at an inclination of 10 degrees when standing on wheels. This technology is useful to meet such safety regulations, but is not limited to this purpose.

The two embodiments described above, in which the residual tipping torque is compared to the residual tipping torque threshold value or it is checked whether the center of gravity of the total load extends through the at least one virtual line, can be used independently of one another to generate the tipping safety signal. Furthermore, the two methods can also be combined with one another.

In one embodiment, the safety unit can have an overload protection unit that generates an overload protection signal based on a defined load and/or the center of gravity of the defined load. The defined load is a load from the group of measured, active, and total loads. The overload protection signal indicates whether there is a risk of overloading the operating table and/or at least one component of the operating table.

The overload protection signal is a safety signal from the safety unit.

The overload protection unit prevents damage, for example, bending or even breaking of a component of the operating table, due to an excessive load acting on the operating table. This also prevents the patient from being endangered.

The at least one component of the operating table for which the risk of overloading is determined can be, for example, a secondary support surface section of the patient table or another accessory of the operating table or another component of the operating table, for example a roller or the operating table column.

If there is a risk of overload, for example, acoustic and/or visual warnings can be generated to the user and/or measures can be taken to prevent the operating table from overloading. For example, movements of the operating table can be blocked or the speed of the operating table can be reduced.

In one configuration, the overload protection unit can compare the defined load to at least one specified overload threshold value. If the defined load exceeds the at least one overload threshold value, the overload protection unit generates the overload protection signal such that it indicates a risk of overloading. The at least one overload threshold value can be specific to the operating table and/or the at least one component. Therefore, an individual overload threshold can be used for each component of the operating table. This makes it possible to determine the overload risk for components of different stability.

In one embodiment, the operating table can have a patient support surface. The patient support surface is used to support the patient, for example during a surgical procedure. The patient support surface can be of modular design and have a main support surface section which can be expanded by coupling on various secondary support surface sections. For this purpose, the main support surface section and the secondary support surface sections can have mechanical connecting elements, using which the main and secondary support surface sections can be detachably connected. For example, secondary support surface sections can be leg or head sections. Furthermore, secondary support surface sections can also be extension or intermediate sections that are inserted, for example, between the main support surface section and the head section.

In one embodiment, the operating table can have a patient support surface having a main support surface section and at least one secondary support surface section. The at least one secondary support surface section can be detachably connected to the main support surface section. In the present embodiment, the at least one secondary support surface section is the at least one component. This embodiment makes it possible to determine a risk of overloading for one or more secondary support surface sections. Furthermore, individual overload risks can be specified for several secondary support surface sections and suitable measures can be taken in the event of an impending overload.

A secondary support surface section can have an individual load limit. A configuration of multiple interconnected secondary support surface sections can have a load limit that is different than the load limits of the individual secondary support surface sections. In particular, the load limit for the interconnected secondary support surface section configuration can be less than the load limit of the individual secondary support surface sections. In one embodiment, this fact is taken into account. For this purpose, an overload threshold value can be specified for the configuration in which the secondary support surface sections are connected to one another and to the main support surface section. The overload protection unit can compare the defined load to the overload threshold value specified for the configuration of the secondary support surface sections and generate the overload protection signal such that it indicates a risk of overload if the defined load exceeds the overload threshold value.

In addition to possible overload risks for individual support surface sections and a configuration of secondary support surface sections, overload risks for specific sections or areas of the patient bed can also be determined. The areas can extend, for example, along the outer boundaries of the secondary support surface sections. In this case, an area comprises a certain number of secondary support surface sections. However, it is also conceivable that an area boundary does not extend along the outer boundaries of the secondary support surface sections. In this case, part of a secondary support surface section can belong to one area, while the remaining part of the secondary support surface section belongs to the adjacent area. In one embodiment, at least part of the patient support surface can therefore be divided virtually or conceptually into multiple areas, and an overload threshold value can be specified for each area. The overload protection unit checks the area in which the center of gravity of the defined load is located and compares the defined load to the overload threshold value specified for this area. If the defined load exceeds the at least one overload threshold value specified for this area, the overload protection unit can generate the overload protection signal such that it indicates a risk of overloading.

Furthermore, a graph or a curve can be specified, which extends along at least part of the patient support surface. A respective overload threshold value is specified at each point of the at least one part of the patient support surface by the graph or the curve. The graph or the curve can be a straight line, for example. In particular, the straight line can drop towards a distal end of the patient support surface, so that the overload threshold value becomes smaller towards the end of the patient support surface. The overload protection unit can check at which point the center of gravity of the defined load is located on the patient support surface. The formulation “at which point the center of gravity of the defined load is located” does not necessarily mean that the center of gravity of the defined load is within the patient support surface. The center of gravity can also be outside of the patient support surface. In this case, the corresponding point on the patient support surface can be determined, for example, by a vertical projection of the center of gravity onto the patient support surface. The overload protection unit compares the defined load to the overload threshold specified for the determined point and generates the overload protection signal such that it indicates a risk of overload if the defined load exceeds the overload threshold specified for that point.

In one embodiment, the operating table can have at least one drive. The overload protection unit can use the measurement load and/or the center of gravity of the measurement load to determine a load acting on the at least one drive and compare the determined load to at least one specified overload threshold value. If the determined load exceeds the at least one overload threshold value, the overload protection unit can generate the overload protection signal such that it indicates a risk of overloading. This can prevent the drive from being overloaded.

The drive can in particular be an electric drive which is used, for example, to adjust the patient support surface or individual components of the patient support surface, in particular to extend or tip the patient support surface. The operating table can also comprise multiple drives. An individual overload threshold can be specified for each of the drives, which is specific to the respective drive. This allows individual overload risks for the drives to be specified.

According to a second aspect of the present disclosure, a method for operating an operating table is provided. A load sensor assembly of the operating table comprises multiple load sensors and measures at least one variable from which a load acting on the load sensor assembly can be determined. The load sensor assembly is arranged between at least two parts of the operating table. The at least two parts are essentially not movable in relation to one another.

The method according to the second aspect can have all embodiments that are described in the present disclosure in connection with the operating table according to the first aspect.

According to a third aspect of the present disclosure, an operating table comprises a load sensor assembly having multiple load sensors, a load determination unit, and a tipping prevention unit.

The load sensor assembly having the multiple load sensors is used to measure at least one variable from which a load acting on the load sensor assembly can be determined. The load determination unit is coupled to the load sensor unit and uses the measured at least one variable to determine a total load and/or the center of gravity of the total load. The total load results from the load acting on the load sensor assembly and a load caused by components associated with the operating table and located below the load sensor assembly. Based on the total load and/or the center of gravity of the total load, the tipping prevention unit generates a tipping safety signal which indicates whether there is a risk of the operating table tipping over.

The operating table and its components according to the third aspect can have all embodiments that are described in the present disclosure in connection with the operating table and its components according to the first aspect.

If the tipping prevention unit generates the tipping prevention signal such that it indicates a risk of the operating table tipping over, in one embodiment the operating table can generate an acoustic and/or visual warning signal and/or a warning signal in text form and/or a movement of the operating table can be slowed or stopped and/or at least one functionality of the operating table can be blocked.

In one embodiment, the tipping prevention unit can determine a residual tipping torque for at least one tipping point based on the total load and/or the center of gravity of the total load and can compare the residual tipping torque to a specified residual tipping torque threshold value. If the residual tipping torque falls below the residual tipping torque threshold value, the tipping safety signal is generated such that it indicates a risk of tipping.

In one embodiment, the tipping prevention unit can determine the residual tipping torque at the at least one tipping point by the tipping prevention unit multiplying the distance of the at least one tipping point from the center of gravity of the total load by the total load.

In one embodiment, the tipping prevention unit can determine a respective residual tipping torque for a plurality of tipping points, in particular for all possible tipping points, and can compare each of the residual tipping torques to the specified residual tipping torque threshold value. If at least one of the residual tipping torques falls below the residual tipping torque threshold value, the tipping prevention unit can generate the tipping safety signal such that it indicates a risk of tipping.

In one embodiment, at least one virtual line can be specified, which extends through at least one tipping point and which encloses a specified angle, a so-called stability angle, with a specified normal vector. The tipping prevention unit can generate the tipping safety signal such that it indicates a risk of tipping if the center of gravity of the total load extends through the at least one virtual line.

In one embodiment, multiple virtual lines can be specified, each extending through a tipping point and each enclosing a specified angle, a so-called stability angle, with the specified normal vector. The multiple virtual lines can define a space. The tipping prevention unit generates the tipping safety signal such that it indicates a risk of tipping if the center of gravity of the total load leaves the space defined by the multiple virtual lines.

In one embodiment, the predefined stability angle, which a virtual line through a tipping point encloses with the specified normal vector, can depend on the nature of the tipping point.

In one embodiment, the stability angle can be larger if the tipping point is given by a roller. The stability angle can be smaller if the tipping point does not have a roller.

According to a fourth aspect of the present disclosure, a method for operating an operating table is provided. A load sensor assembly of the operating table having multiple load sensors measures at least one variable from which a load acting on the load sensor assembly can be determined. Based on the measured at least one variable, a total load, which results from the load acting on the load sensor assembly and from a load caused by components that are associated to the operating table and located below the load sensor assembly, and/or the center of gravity of the total load is determined. Furthermore, based on the total load and/or the center of gravity of the total load, a tipping safety signal is generated which indicates whether there is a risk of the operating table tipping over.

The method according to the fourth aspect can have all embodiments that are described in the present disclosure in connection with the operating table according to the first aspect and the operating table according to the third aspect.

According to a fifth aspect of the present disclosure, an operating table comprises a load sensor assembly having multiple load sensors, a load determination unit, and an overload protection unit.

The load sensor assembly having the multiple load sensors is used to measure at least one variable from which a load acting on the load sensor assembly can be determined. The load determination unit is coupled to the load sensor unit and uses the measured at least one variable to determine at least one defined load, which is the above-defined measurement load, an active load, or a total load, and/or the center of gravity of the defined load. Based on the defined load and/or the center of gravity of the defined load, the overload protection unit generates an overload protection signal that indicates whether there is a risk of overloading the operating table and/or at least one component of the operating table.

The operating table and its components according to the fifth aspect can have all embodiments that are described in the present disclosure in connection with the operating table and its components according to the first aspect.

If the overload protection unit generates the overload protection signal such that it indicates a risk of overload for the operating table and/or the at least one component of the operating table, in one embodiment an acoustic and/or visual warning signal and/or a warning signal in text form can be generated and/or a movement of the operating table is slowed down or stopped and/or at least one functionality of the operating table is blocked.

In one embodiment, the overload protection unit can compare the defined load to at least one predetermined overload threshold value and generate the overload protection signal such that it indicates a risk of overload if the defined load exceeds the at least one overload threshold value. The at least one overload threshold value can be specific to the operating table and/or the at least one component.

In one embodiment, the operating table can have a patient support surface having a main support surface section and at least one secondary support surface section that is detachably connected to the main support surface section, wherein the at least one component is the at least one secondary support surface section.

In one embodiment, the patient support surface can have multiple secondary support surface sections, wherein an overload threshold value is specified for the configuration in which the secondary support surface sections are connected to one another and to the main support surface section. The overload protection unit can compare the defined load to the overload threshold value specified for the configuration of the secondary support surface sections and generate the overload protection signal such that it indicates a risk of overload if the defined load exceeds the overload threshold value.

In one embodiment, at least part of the patient support surface can be divided virtually into multiple areas, and an overload threshold value can be specified for each area. The overload protection unit can check the area in which the center of gravity of the defined load is located and compare the defined load to the overload threshold value specified for this area. The overload protection unit can generate the overload protection signal such that it indicates a risk of overloading if the defined load exceeds the at least one overload threshold value specified for this area.

In one embodiment, a respective overload threshold value can be specified for each point of at least part of the patient support surface. The overload protection unit can check at which point on the patient support surface the center of gravity of the defined load is located and compare the defined load to the overload threshold value specified for this point. The overload protection unit can generate the overload protection signal such that it indicates a risk of overloading if the defined load exceeds the at least one overload threshold value specified for this area.

In one embodiment, the operating table can have at least one drive. The overload protection unit can use the measurement load and/or the center of gravity of the measurement load to determine a load acting on the at least one drive and compare the load determined with at least one specified overload threshold value. The overload protection signal can be generated such that it indicates a risk of overloading if the determined load exceeds the at least one overload threshold value.

According to a sixth aspect of the present disclosure, a method for operating an operating table is provided. A load sensor assembly of the operating table having multiple load sensors measures at least one variable from which a load acting on the load sensor assembly can be determined. The measured at least one variable is used to determine at least one defined load, which can be the above-defined measurement load, an active load, or a total load, and/or the center of gravity of the defined load. Based on the defined load and/or the center of gravity of the defined load, an overload protection signal is generated that indicates whether there is a risk of overloading the operating table and/or at least one component of the operating table.

The method according to the sixth aspect can have all embodiments that are described in the present disclosure in connection with the operating table according to the first aspect and the operating table according to the fifth aspect.

The present disclosure also comprises circuitry and/or electronic instructions for controlling operating tables.

### BRIEF DESCRIPTION OF THE DRAWINGS

Exemplary embodiments of the present disclosure are explained in more detail below with reference to the figures. In the figures:

FIG. 1 shows a schematic side view of an operating table having a patient positioned on a patient support surface of the operating table;

FIG. 2 shows a schematic representation of the system architecture of an operating table according to the disclosure having a load sensor assembly, a load determination unit, and a safety unit;

FIG. 3 shows a schematic representation of an operating table according to the disclosure to illustrate the measurement load, the active load, and the total load;

FIGS. 4A to 4C show schematic representations of different embodiments of an operating table according to the disclosure having a load sensor assembly arranged between two parts not movable in relation to one another;

FIGS. 5A to 5D show schematic representations of different embodiments of an operating table according to the disclosure having force sensors arranged in parallel and mirror-symmetrically;

FIGS. 6A and 6B show schematic representations to illustrate the forces acting on the force sensors;

FIGS. 7A and 7B show schematic representations to illustrate the reduction of transverse forces due to the symmetrical arrangement of the force sensors;

FIG. 8 shows a schematic representation to illustrate the determination of the gravitational vector in the case of an inclined patient support surface;

FIG. 9 shows a schematic representation of an operating table according to the disclosure having a load sensor assembly, a load determination unit, and a tipping prevention unit;

FIGS. 10A and 10B show schematic representations of an operating table according to the disclosure in a locked and unlocked position with tipping points;

FIGS. 11A and 11B show schematic representations of an operating table according to the disclosure having a center of gravity of the total load inside or outside the footprint of the tipping points;

FIG. 12 shows a schematic representation of an operating table according to the disclosure with virtual 5 or 10 degree lines;

FIG. 13 shows a schematic representation of an operating table according to the disclosure having a load sensor assembly, a load determination unit, and an overload protection unit;

FIG. 14 show a schematic representation of an operating table according to the disclosure having a configuration made up of extension sections;

FIGS. 15A and 15B show schematic representations of an operating table according to the disclosure having different load limits in sections or points; and

FIG. 16 shows a schematic representation of an operating table according to the disclosure in an extreme Trendelenburg position.

### DETAILED DESCRIPTION OF THE FIGURES

In the following description, exemplary embodiments of the present disclosure are described with reference to the drawings. The drawings are not necessarily to scale, but are only intended to schematically illustrate the respective features.

It is to be noted that the features and components described below can each be combined with one another, regardless of whether they have been described in connection with a single embodiment. The combination of features in the respective embodiments is only used to illustrate the basic structure and the mode of operation of the claimed device.

In the figures, identical or similar elements are provided with identical reference signs, insofar as this is appropriate.

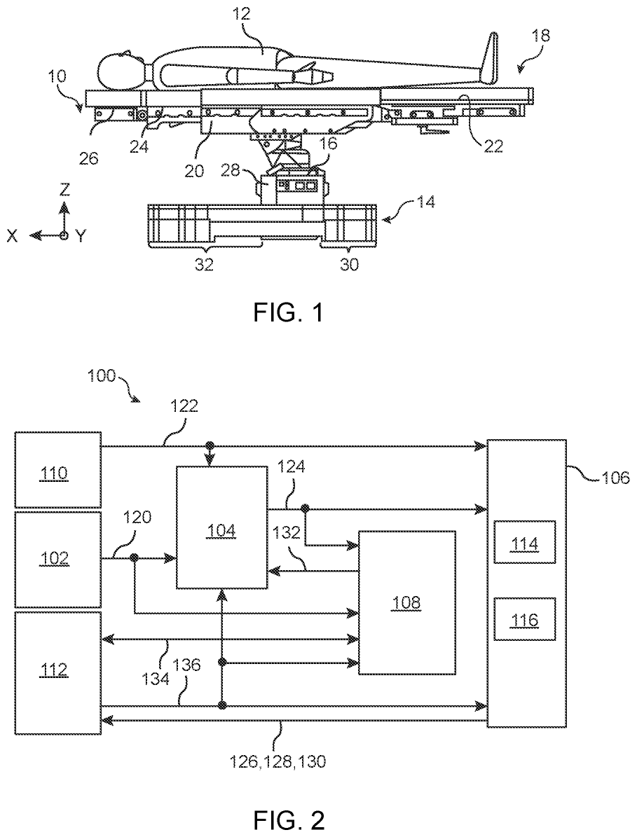

FIG. 1 schematically shows a mobile operating table 10 which can be used to support a

patient 12 during a surgical procedure and to transport them. From bottom to top, the mobile operating table 10 comprises a stand 14 for placing the operating table 10 on an underlying surface, a vertically arranged operating table column 16 comprising the stand 14, and a patient support surface 18 attached to an upper end of the operating table column 16. The patient support surface 18 can be permanently connected to the operating table column 16 or, alternatively, can be detechably fastened on the operating table column 16.

The patient support surface 18 has a modular design and is used to support the patient 12. The patient support surface 18 comprises a main support surface section 20 connected to the operating table column 16, which can be expanded as desired by coupling on various secondary support surface sections. In FIG. 1, a leg section 22, a shoulder section 24, and a head section 26 are coupled to the main support surface section 10 as secondary support surface sections.

Depending on the type of surgical procedure to be performed, the patient support surface 18 of the operating table 10 can be brought to a suitable height and can be tipped and also inclined.

The operating table column 16 is adjustable in height and has an internal mechanism for adjusting the height of the patient support surface 18 of the operating table 10. The mechanism is arranged in a housing 28, which protects the components from soiling.

The stand 14 has two sections 30, 32 of different lengths. The section 30 is a short section associated with a foot end of the leg section 22, i.e., the end of the patient support surface 18 on which the feet of the patient 12 to be treated rest. The section 32 is a long section associated with the head section 26 of the patient support surface 18.

Furthermore, the stand 14 can have wheels or rollers, using which the operating table 10 can be moved on the floor. Alternatively, the stand 14 can be firmly anchored to the floor.

A Cartesian coordinate system X-Y-Z is plotted in FIG. 1 for better illustration. The X-axis and Y-axis are the horizontal axes, the Z-axis is the vertical axis. The X-axis extends along the secondary support surface sections 22, 24, 26 arranged adjacent to one another.

FIG. 2 schematically shows the system architecture of an operating table 100 according to the disclosure. The operating table 100 has a load sensor assembly 102, a load determination unit 104, a safety unit 106, a monitoring and calibration unit 108, a data memory 110, and other components 112 of the operating table 100. Furthermore, the safety unit 106 contains a tipping prevention unit 114 and an overload protection unit 116.

The load sensor assembly 102 contains multiple load sensors and is designed to measure at least one variable from which a load acting on the load sensor assembly 102 can be determined. In the present case, the load sensors are force sensors, each of which measures a force acting on the respective sensor. The force values measured by the individual force sensors are output by the load sensor assembly 102 as a signal 120 in digital form. Furthermore, the load sensor assembly 102 contains electronic components which are necessary for the operation of the force sensors.

The load determination unit 104 receives the signal 120 having the measured force values and uses it to determine a desired load and/or a load center of gravity. In detail, the load determination unit 104 can determine a measurement load, an active load, and/or a total load and the associated load centers of gravity.

In order to be able to adequately process and analyze the delivered force values, the load determination unit 104 requires some data on the geometry and the masses or weights of the operating table 100 and the accessories. These data are stored in the data memory 110 and are made available to the load determination unit 104 by means of a signal 122. In particular, information on the masses and centers of gravity of the individual components of the operating table 100 and the accessories can be taken from these data. The data memory 110 is expandable via a connectivity module of the operating table 100.

The load determination unit 104 generates a signal 124 as an output signal, which contains information about the determined loads and the load centers of gravity. This information is transmitted to the safety unit 106, where all available data are analyzed, including the loads, centers of gravity, and the position data of the operating table 100 and the accessories recognized by the operating table 100.

The safety unit 106 decides whether the operating table 100 is safe or whether it is in a dangerous situation. The safety unit 106 generates a safety signal 126 which indicates whether the operating table 100 is in a safety-critical state.

Depending on the severity of the detected situation, the algorithm reacts accordingly. For example, the operating table 100 may only issue a warning or stop the movement. The warnings can be given by the operating table 100 via an acoustic or visual signal or in the form of text via the remote control. The measures can vary from slowing the speed of movement to stopping the movement to blocking some functionalities and continue until a state is reached in which the operating table 100 is safe again.

It can be provided that the safety functions can be deactivated by the user at any time and the movement of the operating table 100 can be continued at his own risk.

The tipping prevention unit 114 and the overload protection unit 116 are sub-units of the safety unit 106. Based on the total load and/or the center of gravity of the total load, the tipping prevention unit 114 generates a tipping safety signal 128 which indicates whether there is a risk of the operating table 100 tipping over. Based on the active load and/or the center of gravity of the active load, the overload protection unit 116 generates an overload protection signal 130 that indicates whether there is a risk of overloading the operating table 100 and/or at least one component of the operating table 100. Alternatively, the overload protection unit 116 can use the measurement load or the total load and/or the center of gravity of one of these loads to generate the overload protection signal 130. Both the tipping safety signal 128 and the overload protection signal 130 are safety signals of the safety unit 106.

If the stand 14 does not have wheels or rollers and is instead firmly connected to the floor, the tipping prevention unit 114 can be deactivated or not implemented in the safety unit 106.

Since the system is to reliably detect critical situations, the system also has a monitoring and calibration unit 108. This software module checks the plausibility of the measured values and recognizes whether the system is working incorrectly or whether the system needs to be calibrated or tared. The monitoring and calibration unit 108 generates corresponding output signals 132, 134, which are transmitted to the load determination unit 104 or the components 112 of the operating table 100.

The components 112 of the operating table 100 continuously generate position data, data for the adjustment of individual components, and information about the accessories recognized by the operating table 100. These data are made available to the system using a signal 136.

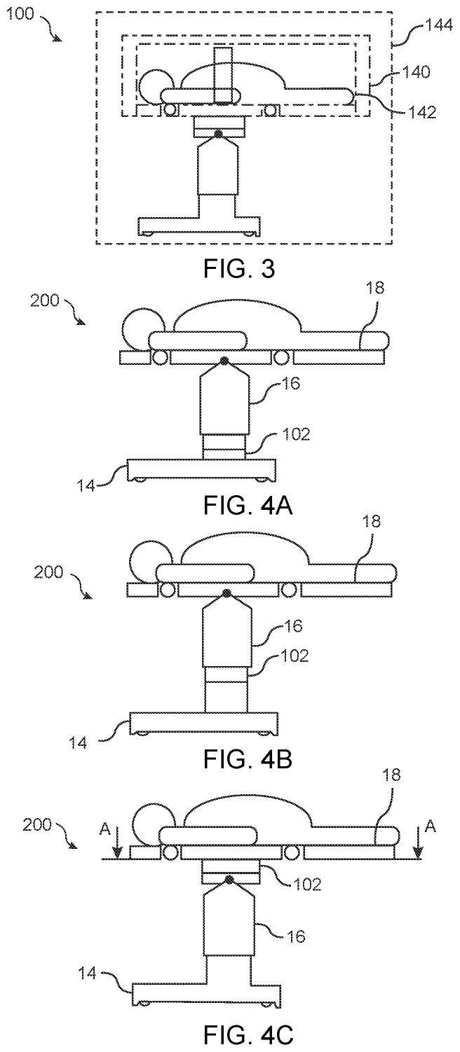

FIG. 3 schematically illustrates the various loads that the load determination unit 104 can determine based on the data obtained from the load sensor unit 102. In FIG. 3, the measurement load, the active load, and the total load are identified by reference numerals 140, 142, and 144, respectively.

The measurement load is the load that acts on the load sensor assembly 102. The measurement load corresponds to the load generated by all people, objects, and forces on the operating table 100 above the load sensors. The measurement load corresponds to the load value measured by the load sensor assembly 102.

The active load corresponds to the load which is caused by components that are not associated with the operating table 100 and people and external forces and which acts on the operating table 100. The influence of the components associated with the operating table 100 is not taken into consideration in the active load. Only the remaining components of the operating table 100 contribute to the active load, i.e., the components not associated with the operating table 100. For example, these can be accessories that are not recognized by the operating table 100. Furthermore, the patient on the operating table 100 contributes to the active load. All forces acting externally on the operating table 100, which are exerted on the operating table 100 by people and/or objects outside the operating table 100, for example, also contribute to the active load. The active load is basically the measurement load without the influence of the known objects such as table top parts, recognized accessories etc.

The total load is that load which results from the measurement load and from a load caused by components which are associated with the operating table 100 and are located below the load sensor assembly 102. The total load therefore takes into consideration loads from components that are located below the load sensor assembly 102 and cannot be measured by the load sensor assembly 102 and therefore do not contribute to the measurement load. The total load is therefore the load resulting from the entire operating table 100, the patient, the components associated with the operating table 100, the components not associated with the operating table 100, and other external forces.

FIGS. 4A to 4C schematically show an operating table 200 according to the disclosure in various embodiments. The operating table 200 is largely similar to the operating table 100 schematically shown in FIG. 2. Elements of the operating table 200 that are identical or similar to elements of the operating table 100 are given identical reference numerals.

The operating table 200 is an operating table according to the first aspect of the present application and can be operated using a method according to the second aspect.

In the operating table 200 the load sensor assembly 102 having the multiple load sensors is arranged between at least two parts of the operating table 200. The at least two parts are essentially not movable in relation to one another. If the operating table 200, in particular the patient support surface 18, is moved or adjusted during operation, for example, when tipping and/or extending the patient support surface 18, the at least two parts essentially do not move in relation to one another, i.e., they remain essentially in the same position in relation to one another. This applies both to the distance of the at least two parts from one another and to the angle or angles that the at least two parts enclose with one another.

The load sensor assembly 102 is preferably integrated into the operating table 200 such that the entire load above the load sensors flows or is transmitted through the load sensor assembly 102.

The load sensor assembly 102 can be arranged at different positions in the operating table 200. In the embodiment shown in FIG. 4A, the load sensor assembly 102 is arranged between the stand 14 and the operating table column 16, while the load sensor assembly 102 in FIG. 4B is integrated into the operating table column 16. In FIG. 4C, the load sensor assembly 102 is located adjacent to the interface between the patient support surface 18 and the operating table column 16.

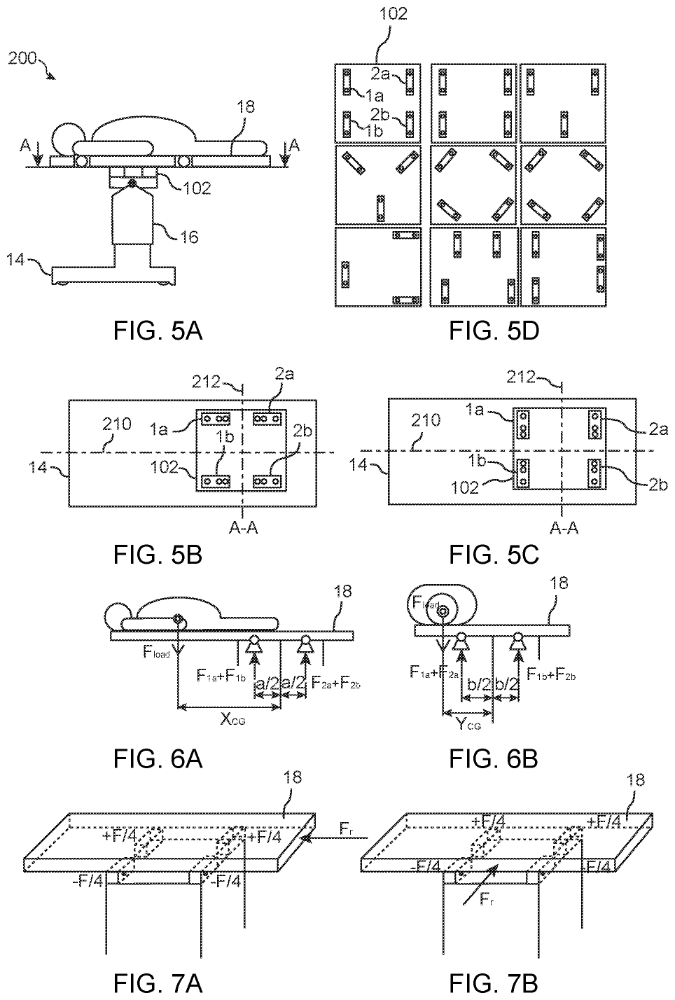

FIG. 5A shows the operating table 200 having a load sensor assembly 102 arranged between the patient support surface 18 and the operating table column 16. The load sensor assembly 102 contains four structurally identical force sensors 1a, 1b, 2a and 2b which are arranged parallel and in mirror image to one another. Two different variants for placing the force sensors 1a, 1b, 2a, 2b are illustrated in FIGS. 5B and 5C. FIGS. 5B and 5C each show a top view of the load sensor assembly 102 along a line A-A indicated in FIG. 5A.

To align the force sensors 1a, 1b, 2a, 2c, a first axis 210 and a second axis 212 are specified, which are perpendicular to one another. The first axis 210 extends parallel to a main axis of the patient support surface 18, while the second axis 212 extends perpendicular to this main axis but parallel to the patient support surface 18.

The force sensors 1a, 1b, 2a, 2c each have a main axis which is aligned parallel to the first axis 210 in FIG. 5B. The main axes of the force sensors 1a, 1b, 2a, 2b are aligned parallel to the second axis 212 in FIG. 5C. Furthermore, the force sensors 1a, 1b, 2a, 2b are arranged in pairs with minor symmetry to the axes 210, 212. The pairs (1a, 1b), (1a, 2a), (1b, 2b), and (2a, 2b) each form a minor-symmetrical pair of force sensors. In some embodiments, the force sensors 1a, 1b, 2a, 2b are arranged in a 2×2 grid as shown. In some embodiments, the grid arrangement has at least two force sensors 1a, 1b, 2a, 2b on each side. In some embodiments, the force sensors 1a, 1b, 2a, 2b all lie in a single common plane that is intersected by both the first axis 210 and the second axis 212.

The force sensors can also be arranged within the sensor assembly 102 differently than in FIGS. 5B and 5C. Several exemplary alternative arrangements of the force sensors in the sensor assembly 102 are illustrated in FIG. 5D.

Using the example of the sensor assembly 102 shown in FIG. 5B or 5C, the measured load can be calculated by adding all the forces measured by the sensors 1a, 1b, 2a, 2b. The appropriate center of gravity can be calculated using the torque balance equation indicated below and the forces shown in FIGS. 6A and 6B. FIG. 6A shows a sectional view along the x-axis and FIG. 6B shows a sectional view along the y-axis. The torque balance equation can be applied in both directions, so the x and y components of the center of gravity can be determined:

$$\begin{matrix}{F}_{load} = {F}_{1 a} + {F}_{2 a} + {F}_{1 b} + {F}_{2 b} & ( 1 ) \\ {X}_{cg} = \frac{{F}_{1 a} + {F}_{1 b}}{{F}_{load}} a - \frac{a}{2} & ( 2 ) \\ {Y}_{cg} = \frac{{F}_{1 a} + {F}_{2 a}}{{F}_{load}} b - \frac{b}{2} & ( 3 )\end{matrix}$$

In equations (1) to (3), F load is the weight force generated by the patient. The forces F₁ₐ, F_{1b}, F₂ₐ, and F_{2b} are the forces measured by the sensors 1a, 1b, 2a, 2b. The parameters a and b are the distances between the sensors in the x and y directions. X_{cg} and Y_{cg} are the x and y coordinates, respectively, of the center of gravity of the load caused by the patient.

The active load and total load and their respective center of gravity values can be calculated by adding or subtracting the respective components of the operating table 200 and their center of gravity values stored in the data memory 110.

The arrangement of the sensors 1a, 1b, 2a, 2b proposed in FIGS. 5B and 5C makes the system robust against lateral forces. Because of the symmetrical arrangement, transverse forces are canceled as shown in FIGS. 7A and 7B.

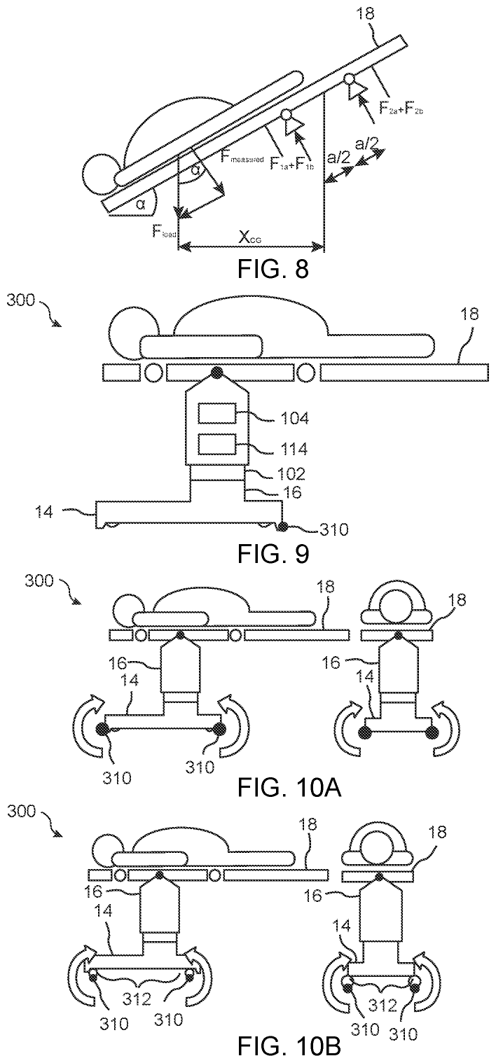

The cancellation of the lateral forces also allows the described system to reliably measure forces and center of gravity when the patient support surface 18 is in an inclined position. FIG. 8 shows how the gravitational vector F_{load} can be split into two components. One component is lateral to the force sensors and is canceled due to the above-explained effects. The second component F_{measured} extends perpendicular to the force sensors and is reliably measured. If the angle of inclination a of the patient support surface 18 is known, the actual load over the sensors and their center of gravity can be calculated.

FIG. 9 schematically shows an operating table 300 according to the disclosure, which is largely similar to the operating table 100 shown schematically in FIG. 2. Elements of the operating table 300 that are identical or similar to elements of the operating table 100 are given identical reference numerals.

The operating table 300 is an operating table according to the third aspect of the present application and can be operated using a method according to the fourth aspect.

The operating table 300 comprises a load sensor assembly 102 having multiple load sensors, a load determination unit 104, and a tipping prevention unit 114. The load determination unit 104 uses the forces measured by the force sensors to ascertain the total load of the operating table 300 and the center of gravity of the total load. Based on the total load and/or the center of gravity of the total load, the tipping prevention unit 114 generates a tipping safety signal 128 which indicates whether there is a risk of the operating table 300 tipping over around a tipping point 310.

FIGS. 10A and 10B show the operating table 300 from the side and from the front, respectively. In FIG. 10A the operating table 300 is in the lowered or locked position, i.e., the stand 14 is on the floor so that the operating table 300 cannot be moved. In this position, the operating table 300 can tip around the lower side edges of the stand 14, which face toward the floor.

In FIG. 10B, the operating table 300 is in the unlocked position, i.e., the operating table 300 stands on rollers 312 and can be moved on the floor. In this position, possible tipping points are given by the rollers 312.

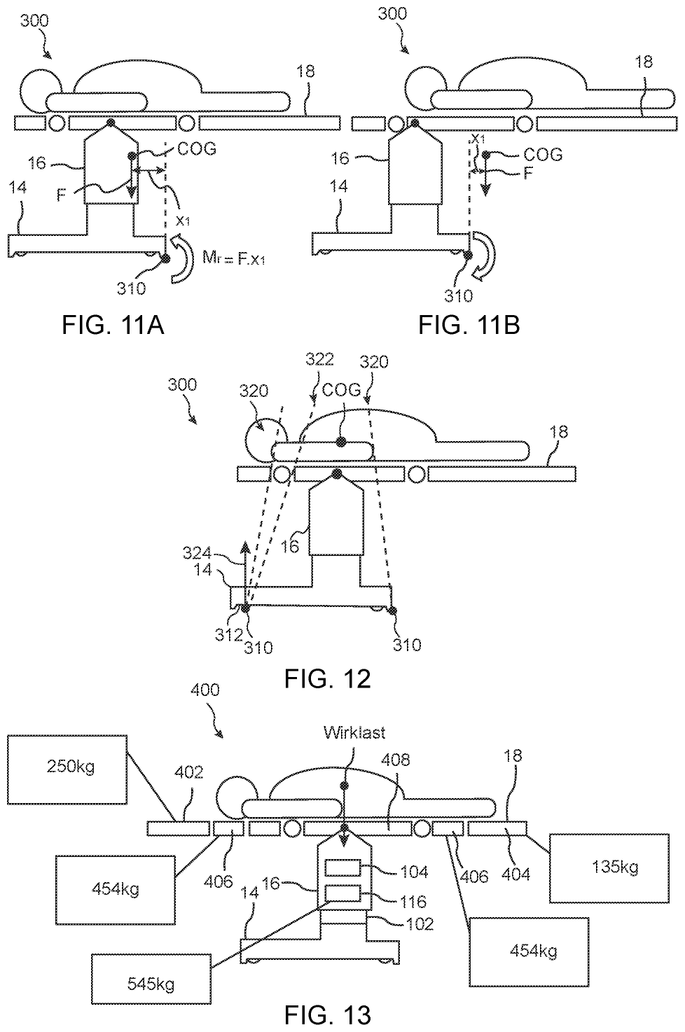

In principle, the operating table 300 is stable as long as the center of gravity COG of the total load lies within the footprint of the tipping points 310, i.e., directly above an area bounded by the tipping points 310. Illustratively, this situation is shown in FIG. 11A. However, if the center of gravity COG of the total load is not directly above the footprint of the tipping points 310, as shown in FIG. 11B, the operating table 300 tips over.

In one embodiment, the tipping prevention unit 114 ascertains a residual tipping torque Mᵣ at a tipping point 310 by multiplying the distance x₁ between the tipping point 310 and the center of gravity COG of the total load by the total load. In FIGS. 11A and 11B, a force vector F is shown as the total load and the distance x₁ between the force vector F and the tipping point 310 is also shown. Therefore, Mᵣ=F*ₓ₁ applies for the residual tipping torque Mᵣ. A positive value for the residual tipping torque Mᵣ means that the operating table 300 is stable with respect to this tipping point 310 (cf. FIG. 11A). As the distance x₁ decreases, the residual tipping torque Mᵣ also decreases and the operating table 300 becomes less stable. If the residual tipping torque Mᵣ is negative, which means that the center of gravity COG and the force vector F are not directly above the area delimited by the tipping points 310, the operating table 300 tips over (cf. FIG. 11B). The greater the value of the residual tipping torque Mᵣ, the more stable the operating table 300. A residual breakdown torque threshold value is specified, which has a value of 225 Nm, for example. This means that the residual tipping torque is not to be less than 225 Nm. If the residual tipping torque threshold value is not reached, the operating table 300 can warn the user acoustically or visually. Other possibilities are blocking movements or reducing the speed of the operating table 300.

Furthermore, the tipping prevention unit 114 can determine a respective residual tipping torque for all possible tipping points and compare these residual tipping torques to the residual tipping torque threshold value. If only one of the tipping torques falls below the residual tipping torque threshold value, the tipping prevention unit 114 can determine that there is an increased risk of tipping and appropriate measures can be taken.

A further embodiment for ascertaining the risk of tipping is based on the stability requirements of norm 60601-1. Norm 60601-1 stipulates that the operating table 300 has to remain stable at an inclination of 5 degrees under all circumstances of the intended use and that it has to remain stable at an inclination of 10 degrees only for the defined transport position. This requirement can be translated into a virtual 5 degree line 320 at each tipping point and a 10 degree line 322 at each tipping point having a roller 312 as shown in FIG. 12. The angles of 5 and 10 degrees can be referred to as the stability angles. Therefore, in some embodiments, there is a first angle of stability when the operating table is standing directly on the floor and a second, larger angle of stability when the operating table is in a transport position on rollers or wheels.

The stability angles (of 5 or 10 degrees, for example) are determined by means of a specified normal vector 324. The normal vector 324 can be defined, for example, by the base plate of the stand 14 or the patient support surface 18 in the normal position, i.e., in the non-extended position. The normal vector 324 is aligned perpendicular to the base plate of the stand 14 or perpendicular to the patient support surface 18 in the normal position. Instead of the 5 or 10 degree stability angle with the normal vector 324, other suitable stability angles can also be selected for the virtual lines 320, 322.

If the center of gravity COG of the total load violates, i.e., crosses, one of the virtual 5 degree lines 320, the operating table 300 can warn the user acoustically or visually. Other possibilities are the partial or complete blocking of functionalities or the reduction of the speed of the operating table 300. If any of the virtual 10 degree lines 322 are crossed by the center of gravity COG, the motorized transport function of the operating table 300 can become blocked.

A three-dimensional space is defined by the virtual 5-degree lines 320 and the virtual 10-degree lines 322 in each case. Typically, the “walls” of the three-dimensional space incline inward as one moves further up from the base of the operating table 300, so that the center of gravity COG is more strongly restricted laterally at a higher center of gravity COG than at a lower center of gravity COG lying closer to the ground. The inwardly-directed inclination of the “walls” of the three-dimensional space is determined by the stability angle. In one embodiment, the tipping prevention unit 114 can indicate a risk of tipping if the center of gravity COG of the total load leaves one of the defined spaces.

FIG. 13 schematically shows an operating table 400 according to the disclosure, which is largely similar to the operating table 100 shown schematically in FIG. 2. Elements of the operating table 400 that are identical or similar to elements of the operating table 100 are given identical reference numerals.

The operating table 400 is an operating table according to the fifth aspect of the present application and can be operated using a method according to the sixth aspect.

The operating table 400 comprises a load sensor assembly 102 having multiple load sensors, a load determination unit 104, and an overload protection unit 116. The load determination unit 104 uses the forces measured by the force sensors to ascertain the active load and/or the center of gravity of the active load. The overload protection unit 116 uses the active load and/or the center of gravity of the active load to ascertain an overload protection signal 130. The overload protection signal 130 indicates whether there is a risk of overloading the operating table 400 and/or at least one component of the operating table 400.

The overload protection unit 116 can detect whether an accessory or a configuration of accessories is not suitable for the load acting on the operating table 400. The overload protection unit 116 also aids in complying with movement limits that apply to certain weight classes.

Accessories are usually authorized for a patient weight. When a detection procedure is performed to identify the accessories and the operating table 400 is thus informed of which accessories are attached, the overload protection unit 116 can check whether the measured weight does not exceed the weight limit for the accessories. If the weight limit of the operating table 400 or the accessories is exceeded, the operating table 400 can warn the user acoustically or visually. Other possibilities are blocking movements or reducing the speed of the operating table 400.

The operating table 400 shown in FIG. 13 has as accessories a head section 402, a leg section 404, and two extension sections 406 and, which are connected to a main support surface section 408 in the configuration shown. A maximum carrying capacity is given for each of the accessories in FIG. 13. The head section 402 has a maximum carrying capacity of 250 kg, the leg section 404 has a maximum carrying capacity of 135 kg, each of the extension sections 406 has a maximum carrying capacity of 454 kg, and the entire operating table 400 has a maximum carrying capacity of 545 kg. The overload protection unit 116 can check whether one of the components is overloaded.

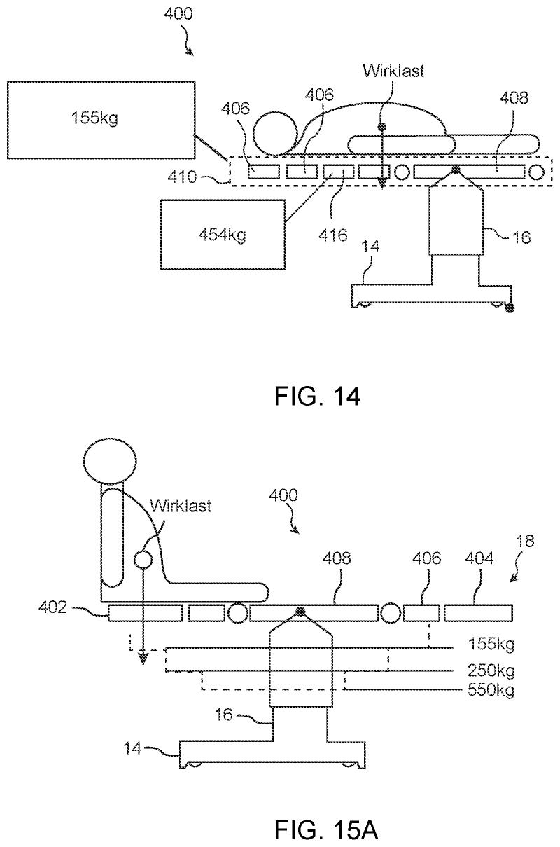

The accessory can also be overloaded if the configuration in which the accessories are interconnected is not suitable for the applied load. For example, as shown in FIG. 14, three extension sections 406 can be cascaded in succession. Although each of the extension sections 406 is individually suitable for a load of 454 kg, a combination 410 of three extension sections 406 is only suitable for 155 kg. Therefore, in some embodiments, the allowable weight for the table configuration is determined by considering a plurality of extension sections 406 connected to the operating table, wherein the addition of more extension sections 406 reduces the allowable weight for the table configuration overall compared to configurations having fewer extension sections 406.

Knowing the active load and the configuration of the operating table 400, the overload protection unit 116 can determine whether or not the permissible weight for the configuration 410 is being exceeded. If the allowable weight is exceeded, the operating table 400 can warn the user acoustically or visually. Other possibilities are blocking movements or reducing the speed of the operating table 400.

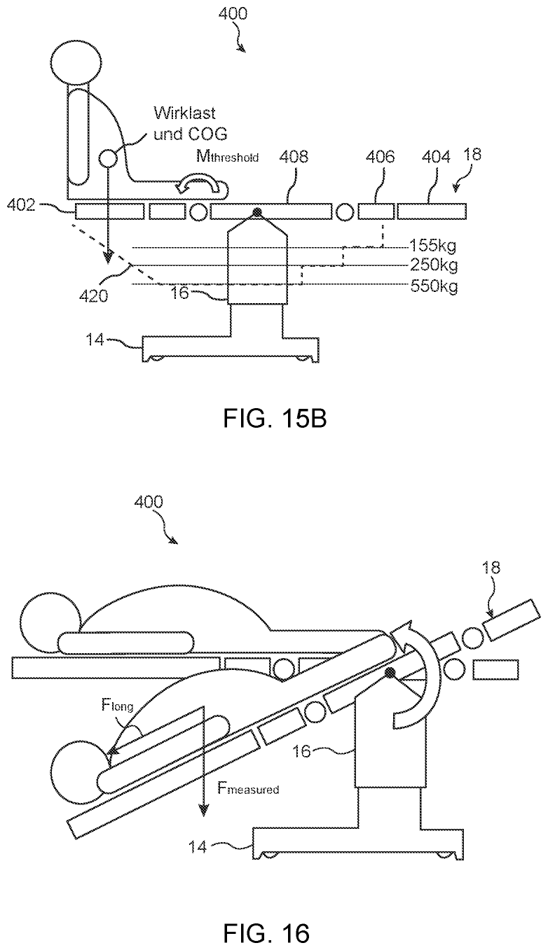

It is also conceivable that an overload situation is caused by incorrect positioning of the patient. For example, the case is shown in FIG. 15A where the patient is seated on the head section 402 and the center of gravity of the entire patient is over the head section 402. Although the accessory 402 is suitable for use by 380 kg patients, the accessory 402 is only intended as a headrest, i.e., sitting on it is not allowed.

The overload protection unit 116 can check the load and its center of gravity position. The overload protection unit 116 can recognize if the patient is improperly positioned and if an accessory or configuration of accessories or the entire operating table 400 is overloaded.

Furthermore, the overload protection unit 116 can also determine overload risks for certain sections or areas of the patient support surface 18. In FIG. 15A, the patient support surface 18 is subdivided by way of example into different areas for which maximum load capacities of 155 kg, 250 kg, or 55 kg apply. The overload protection unit 116 checks the area in which the center of gravity of the active load is located and compares the active load to the overload threshold value specified for this area, i.e., the maximum carrying capacity. If the active load exceeds the maximum carrying capacity specified for this area, the overload protection unit 116 can generate the overload protection signal 130 such that it indicates a risk of overloading.

FIG. 15B shows a refinement of the operating table 400 shown in FIG. 15A. In the embodiment shown in FIG. 15B, the front part of the patient support surface 18 comprising the head section 402 is not divided into different areas, each with a constant overload threshold value; instead, a straight line 420 is specified, which extends along the front part of the patient support surface 18. The straight line 420 specifies a respective overload threshold value for each point of the front part of the patient support surface 18. In the direction of the head end of the patient support surface 18, the overload threshold becomes smaller. The straight line 420 is defined by F/M_{threshold}, wherein F is the force at the center of gravity COG of the active load and M_{threshold} is a constant.

During operation, the overload protection unit 116 checks the point on the patient support surface 18 at which the center of gravity of the active load is located and compares the active load to the overload threshold value specified for this ascertained point. If the active load exceeds the maximum carrying capacity specified for this area, the overload protection unit 116 can generate the overload protection signal 130 such that it indicates a risk of overloading.

Another overload situation occurs when drives of the operating table 400 are overloaded and the operating table 400 cannot return to its original position. This happens, for example, when the movement restrictions are not observed. By way of example, FIG. 16 shows an extreme longitudinal displacement and Trendelenburg position in combination with a heavy patient. This can be a position from which the operating table 400 cannot return to its starting position because the drives for the longitudinal displacement and the Trendelenburg drives are overloaded. In particular, the Trendelenburg drives cannot apply the torque that is generated by the force F_{measured}. In addition, the drives for the longitudinal displacement cannot generate the longitudinal force F_{long}.

The overload protection unit 116 can determine the load of each drive based on the measurement load and/or the center of gravity of the measurement load. For each drive, there is a load limit which is not to be exceeded. If this limit is exceeded, the user will be warned. Other possibilities are blocking movements of the overloaded drives or reducing the speed of the operating table 400.

The following Aspects provide exemplary embodiments of the tables, devices, and methods this disclosure.

Aspect 1. An operating table (100, 200) comprising:
a load sensor assembly (102) having multiple load sensors (1a, 1b, 2a, 2b) for measuring at least one variable, from which a load acting on the load sensor assembly (102) can be determined,
wherein the load sensor assembly (102) is arranged between at least two parts of the operating table (100, 200), and

wherein the at least two parts are essentially not movable in relation to one another.

Aspect 2. The operating table (100, 200) according to aspect 1, wherein the load sensor assembly (102) is integrated into the operating table (100, 200) such that the entire load is transmitted through the load sensor assembly (102).

Aspect 3. The operating table (100, 200) according to aspect 1 or 2, wherein the at least two parts are movable relative to each other only to the extent of the physical deformation of the load sensors (1a, 1b, 2a, 2b), wherein this relative movement is no more than 3 millimeters.

Aspect 4. The operating table (100, 200) according to any one of the preceding aspects, wherein several of the load sensors (1a, 1b, 2a, 2b) are arranged minor-symmetrically with respect to a first axis (210) and minor-symmetrically with respect to a second axis (212),

wherein the first and the second axis (210, 212) are aligned orthogonally to one another, and

wherein the mirror-symmetrically arranged load sensors (1a, 1b, 2a, 2b) are aligned in the same direction.

Aspect 5. The operating table (100, 200) according to any one of the preceding aspects, wherein several of the load sensors (1a, 1b, 2a, 2b) are arranged minor-symmetrically with respect to a first axis (210) and minor-symmetrically with respect to a second axis (212),

wherein the first and the second axis (210, 212) are aligned orthogonally to one another, and

wherein at least some of the load sensors (1a, 1b, 2a, 2b) are in a grid arrangement in a common plane, wherein the grid arrangement has at least two load sensors (1a, 1b, 2a, 2b) on each side,

wherein the common plane is between the at least two parts of the operating table (100, 200); and

wherein the load sensors (1a, 1b, 2a, 2b) in the grid arrangement and the at least two parts of the operating table (100, 200) are all fastened substantially immovably with respect to one another.

Aspect 6. The operating table (100, 200) according to any one of the preceding aspects, wherein the multiple load sensors (1a, 1b, 2a, 2b) are arranged in a single common plane between the at least two parts of the operating table (100, 200).

Aspect 7. The operating table (100, 200) according to any one of the preceding aspects, furthermore comprising a load determination unit (104) which is coupled to the load sensor assembly (102) and uses the measured at least one variable to determine at least one of the following loads and/or one of the following centers of gravity:

a measurement load, which is the load acting on the load sensor assembly (102), and/or the center of gravity of the measurement load,

an active load, which is a load caused by people and components not associated with the operating table (100, 200) and external forces and acts on the operating table (100, 200), and/or the center of gravity of the active load, and

a total load, which results from the measurement load and from a load caused by components which are associated with the operating table (100, 200) and are located below the load sensor assembly (102), and/or the center of gravity of the total load.

Aspect 8. The operating table (100, 200) according to aspect 7, furthermore comprising a safety unit (106), which is coupled to the load determination unit (104) and which, based on at least one of the loads determined by the load determination unit (104) and/or at least one of the centers of gravity determined by the load determination unit (104), generates a safety signal (126) which indicates whether the operating table (100, 200) is in a safety-critical state.

Aspect 9. The operating table (100, 200) according to aspect 8, wherein if the safety unit (106) generates the safety signal (126) such that it indicates a safety-critical state of the operating table (100, 200), an acoustic and/or visual warning signal and/or a textual warning signal is generated and/or a movement of the operating table (100, 200) is slowed down or stopped and/or at least one functionality of the operating table (100, 200) is blocked.

Aspect 10. The operating table (100, 200, 300) according to aspect 8 or 9, wherein the safety unit (106) comprises a tipping prevention unit (114) which, based on the total load and/or the center of gravity of the total load, generates a tipping safety signal (128) which indicates whether there is a risk that the operating table (100, 200, 300) will tip over.

Aspect 11. The operating table (100, 200, 300) according to aspect 10, wherein the tipping prevention unit (114) determines a residual tipping torque for at least one tipping point (310) on the basis of the total load and/or the center of gravity of the total load, compares the residual tipping torque to a predetermined residual tipping torque threshold value, and generates the tipping safety signal (128) such that it indicates a risk of tipping if the residual tipping torque falls below the residual tipping torque threshold value.

Aspect 12. The operating table (100, 200, 300) according to aspect 10 or 11, wherein at least one virtual line (320, 322) is specified, which extends through at least one tipping point (310) and which encloses a specified stability angle with a specified normal vector (324), wherein the tipping prevention unit (114) generates the tipping safety signal (128) such that it indicates a risk of tipping if the center of gravity of the total load extends through the at least one virtual line (320, 322).

Aspect 13. The operating table (100, 200, 400) according to any one of aspects 8 to 12, wherein the safety unit (106) comprises an overload protection unit (116) which, based on a defined load, which is the measured load, the active load, or the total load, and/or the center of gravity of the defined load, generates an overload protection signal (130), which indicates whether there is a risk of overloading the operating table (100, 200, 400) and/or at least one component of the operating table (100, 200, 400).

Aspect 14. The operating table (100, 200, 400) according to aspect 13, wherein the overload protection unit (116) compares the defined load to at least one predetermined overload threshold value and generates the overload protection signal (130) such that it indicates a risk of overloading if the defined load exceeds the at least one overload threshold value, wherein the at least one overload threshold value is specific to the operating table (100, 200, 400) and/or the at least one component.

Aspect 15. The operating table (100, 200, 400) according to aspect 13 or 14, wherein the operating table has a patient support surface (18) having a main support surface portion (408) and at least one secondary support surface portion (402, 404, 406) detachably connected to the main support surface portion (408), wherein the at least one component is the at least one secondary support surface portion (402, 404, 406).

Aspect 16. The operating table (100, 200, 400) according to aspect 15, wherein the patient support surface (18) has multiple secondary support surface portions (402, 404, 406),

wherein an overload threshold value is specified for the configuration (410) in which the secondary support surface portions (402, 404, 406) are connected to each other and to the main support surface portion (408), and

wherein the overload protection unit (116) compares the defined load to the overload threshold value specified for the configuration (410) of the secondary support surface portions (402, 404, 406) and generates the overload protection signal (130) such that it indicates a risk of overload if the defined load exceeds the overload threshold value.

Aspect 17. The operating table (100, 200, 400) according to aspect 15 or 16, wherein at least part of the patient support surface (18) is virtually divided into multiple regions and an overload threshold value is specified for each region, and

wherein the overload protection unit (116) checks the region in which the center of gravity of the defined load is located and compares the defined load to the overload threshold value specified for this region and generates the overload protection signal (130) such that it indicates a risk of overload if the defined load exceeds the overload threshold value specified for this region.

Aspect 18. The operating table (100, 200, 400) according to any one of aspects 15 to 17, wherein a respective overload threshold value is specified for each point of at least part of the patient support surface (18), and

wherein the overload protection unit (116) checks the point of the patient support surface (18) at which the center of gravity of the defined load is located and compares the defined load to the overload threshold value specified for this point and generates the overload protection signal (130) such that it indicates a risk of overload if the defined load exceeds the overload threshold value specified for this point.

Aspect 19. The operating table (100, 200, 400) according to any one of aspects 13 to 18, wherein the operating table (100, 200, 400) has at least one drive, and

wherein the overload protection unit (116) determines a load acting on the at least one drive on the basis of the measurement load and/or the center of gravity of the measurement load and compares the determined load to at least one specified overload threshold value and generates the overload protection signal (130) such that it indicates a risk of overloading if the determined load exceeds the at least one overload threshold value.

Aspect 20. A method for operating an operating table (100, 200), wherein a load sensor assembly (102) of the operating table (100, 200) having multiple load sensors (1a, 1b, 2a, 2b) measures at least one variable from which a load acting on the load sensor assembly (102) may be determined,

wherein the load sensor assembly (102) is arranged between at least two parts of the operating table (100, 200), and

wherein the at least two parts are essentially not movable in relation to one another.

Aspect 21. An operating table (100, 300) comprising:
a load sensor assembly (102) having multiple load sensors (1a, 1b, 2a, 2b) for measuring at least one variable, from which a load acting on the load sensor assembly (102) can be determined,

a load determination unit (104), which is coupled to the load sensor unit (102) and uses the measured at least one variable to determine a total load, which results from the load acting on the load sensor assembly (102) and a load caused by components that are associated with the operating table (100, 300) and are located below the load sensor assembly (102), and/or the center of gravity of the total load, and

a tipping prevention unit (114) which, based on the total load and/or the center of gravity of the total load, generates a tipping safety signal (128) which indicates whether there is a risk of the operating table (100, 300) tipping over.

Aspect 22. The operating table (100, 300) according to aspect 21, wherein if the tipping prevention unit (114) generates the tipping safety signal (128) such that it indicates a risk of tipping of the operating table (100, 300), an acoustic and/or visual warning signal and/or a textual warning signal is generated and/or a movement of the operating table (100, 300) is slowed down or stopped and/or at least one functionality of the operating table (100, 300) is blocked.

Aspect 23. The operating table (100, 300) according to aspect 21 or 22, wherein the tipping prevention unit (114) determines a residual tipping torque for at least one tipping point (310) on the basis of the total load and/or the center of gravity of the total load, compares the residual tipping torque to a predetermined residual tipping torque threshold value, and generates the tipping safety signal (128) such that it indicates a risk of tipping if the residual tipping torque falls below the residual tipping torque threshold value.

Aspect 24. The operating table (100, 300) according to aspect 23, wherein the tipping prevention unit (114) multiplies the distance of the at least one tipping point (310) from the center of gravity of the total load by the total load to determine the residual tipping torque at the at least one tipping point (310).

Aspect 25. The operating table (100, 300) according to any one of aspects 21 to 24, wherein the tipping prevention unit (114) determines a respective residual tipping torque for a plurality of tipping points (310), in particular for all possible tipping points (310), compares each of the residual tipping torques to the predetermined residual tipping torque threshold value, and generates the tipping safety signal (128) such that it indicates a risk of tipping if at least one of the residual tipping torques falls below the residual tipping torque threshold value.

Aspect 26. The operating table (100, 300) according to any one of aspects 21 to 25, wherein at least one virtual line (320, 322) is specified, which extends through at least one tipping point (310) and which encloses a specified stability angle with a specified normal vector (324), wherein the tipping prevention unit (114) generates the tipping safety signal (128) such that it indicates a risk of tipping if the center of gravity of the total load extends through the at least one virtual line (320, 322).

Aspect 27. The operating table (100, 300) according to aspect 26, wherein multiple virtual lines (320, 322) are specified, which each extend through a tipping point (310) and each enclose a specified stability angle with the specified normal vector (324), wherein the multiple virtual lines (320, 322) define a space and the tipping prevention unit (114) generates the tipping safety signal (128) such that it indicates a risk of tipping if the center of gravity of the total load leaves the space defined by the multiple virtual lines (320, 322).

Aspect 28. The operating table (100, 300) according to aspect 26 or 27, wherein the predetermined stability angle enclosed by a virtual line (320, 322) through a tipping point (310) with the predetermined normal vector (324) depends on the nature of the tipping point (310).

Aspect 29. The operating table (100, 300) according to aspect 28, wherein the angle of stability is larger when the tipping point (310) is given by a roller (312) and otherwise is smaller.

Aspect 30. A method for operating an operating table (100, 300), wherein a load sensor assembly (102) of the operating table (100, 300) having multiple load sensors (1a, 1b, 2a, 2b) measures at least one variable from which a load acting on the load sensor assembly (102) may be determined,

wherein the measured at least one variable is used to determine a total load, which results from the load acting on the load sensor assembly (102) and a load caused by components that are associated with the operating table (100, 300) and are located below the load sensor assembly (102), and/or the center of gravity of the total load, and

wherein, based on the total load and/or the center of gravity of the total load, a tipping safety signal (128) is generated which indicates whether there is a risk of the operating table (100, 300) tipping over.

Aspect 31. An operating table (100, 400) comprising:
a load sensor assembly (102) having multiple load sensors (1a, 1b, 2a, 2b) for measuring at least one variable, from which a load acting on the load sensor assembly (102) can be determined,

a load determination unit (104), which is coupled to the load sensor unit (102) and uses the measured at least one variable to determine at least one defined load, which is a measurement load, an active load, or a total load, and/or determines the center of gravity of the defined load, and

an overload protection unit (116), which, based on the defined load and/or the center of gravity of the defined load, generates an overload protection signal (130) that indicates whether there is a risk of overloading the operating table (100, 400) and/or at least one component of the operating table (100, 400),

wherein the measurement load is the load acting on the load sensor assembly (102),

wherein the active load is a load caused by people and components not associated with the operating table (100, 400) and by external forces and acts on the operating table (100, 400), and

wherein the total load is that load which results from the measurement load and from a load caused by components which are associated with the operating table (100, 400) and are located below the load sensor assembly (102).

Aspect 32. The operating table (100, 400) according to aspect 31, wherein if the overload protection unit (116) generates the overload protection signal (130) such that it indicates a risk of overloading the operating table (100, 400) and/or the at least one component of the operating table (100, 400), an acoustic and/or visual warning signal and/or a textual warning signal is generated and/or a movement of the operating table (100, 400) is slowed down or stopped and/or at least one functionality of the operating table (100, 400) is blocked.

Aspect 33. The operating table (100, 400) according to aspect 31 or 32, wherein the overload protection unit (116) compares the defined load to at least one predetermined overload threshold value and generates the overload protection signal (130) such that it indicates a risk of overloading if the defined load exceeds the at least one overload threshold value, wherein the at least one overload threshold value is specific to the operating table (100, 400) and/or the at least one component.

Aspect 34. The operating table (100, 400) according to any one of aspects 31 to 33, wherein the operating table (100, 400) has a patient support surface (18) having a main support surface portion (408) and at least one secondary support surface portion (402, 404, 406) detachably connected to the main support surface portion (408), wherein the at least one component is the at least one secondary support surface portion (402, 404, 406).

Aspect 35. The operating table (100, 400) according to aspect 34, wherein the patient support surface (18) has multiple secondary support surface portions (402, 404, 406),

wherein an overload threshold value is specified for the configuration (410) in which the secondary support surface portions (402, 404, 406) are connected to each other and to the main support surface portion (408), and

wherein the overload protection unit (116) compares the defined load to the overload threshold value specified for the configuration (410) of the secondary support surface portions (402, 404, 406) and generate the overload protection signal (130) such that it indicates a risk of overload if the defined load exceeds the overload threshold value.

Aspect 36. The operating table (100, 400) according to aspect 34 or 35, wherein at least part of the patient support surface (18) is virtually divided into multiple regions and an overload threshold value is specified for each region, and

wherein the overload protection unit (116) checks the region in which the center of gravity of the defined load is located and compares the defined load to the overload threshold value specified for this region and generates the overload protection signal (130) such that it indicates a risk of overload if the defined load exceeds the exceeds the overload threshold value specified for this region.

Aspect 37. The operating table (100, 400) according to any one of aspects 34 to 36, wherein a respective overload threshold value is specified for each point of at least part of the patient support surface (18), and

wherein the overload protection unit (116) checks the point at which the center of gravity of the defined load is located and compares the defined load to the overload threshold value specified for this point and generates the overload protection signal (130) such that it indicates a risk of overload if the defined load exceeds the overload threshold value specified for this point.

Aspect 38. The operating table (100, 400) according to any one of aspects 31 to 37, wherein the operating table (100, 400) has at least one drive, and

wherein the overload protection unit (116) determines a load acting on the at least one drive on the basis of the measurement load and/or the center of gravity of the measurement load and compares the determined load to at least one specified overload threshold value and generates the overload protection signal such that it indicates a risk of overloading if the determined load exceeds the at least one overload threshold value.

Aspect 39. A method for operating an operating table (100, 400), wherein a load sensor assembly (102) of the operating table (100, 400) having multiple load sensors (1a, 1b, 2a, 2b) measures at least one variable from which a load acting on the load sensor assembly (102) may be determined,

wherein the measured at least one variable is used to determine at least one defined load, which is a measurement load, an active load, or a total load, and/or the center of gravity of the defined load, and

wherein based on the defined load and/or the center of gravity of the defined load, an overload protection signal (130) is generated that indicates whether there is a risk of overloading the operating table (100, 400) and/or at least one component of the operating table (100, 400),

wherein the measurement load is the load acting on the load sensor assembly (102),

wherein the active load is a load caused by people and components not associated with the operating table (100, 400) and by external forces and acts on the operating table (100, 400), and

wherein the total load is that load which results from the measurement load and from a load caused by components which are associated with the operating table (100, 400) and are located below the load sensor assembly (102).

1. An operating table (100, 200) comprising:
a load sensor assembly (102) having a plurality of load sensors (1a, 1b, 2a, 2b) for measuring at least one variable, from which a load acting on the load sensor assembly (102) can be determined,
wherein the load sensor assembly (102) is arranged between at least two parts of the operating table (100, 200), and
wherein the at least two parts are essentially not movable in relation to one another.

2. The operating table (100, 200) according to claim 1, wherein the load sensor assembly (102) is integrated into the operating table (100, 200) such that the entire load is transmitted through the load sensor assembly (102).

3. The operating table (100, 200) according to claim 1, wherein the at least two parts are movable relative to each other only to the extent of the physical deformation of the load sensors (1a, 1b, 2a, 2b), wherein this relative movement is no more than 3 millimeters.

4. The operating table (100, 200) according to claim 1, wherein a plurality of the load sensors (1a, 1b, 2a, 2b) are arranged minor-symmetrically with respect to a first axis (210) and mirror-symmetrically with respect to a second axis (212),
wherein the first and the second axis (210, 212) are aligned orthogonally to one another, and
wherein the minor-symmetrically arranged load sensors (1a, 1b, 2a, 2b) are aligned in the same direction.

5. The operating table (100, 200) according to claim 1, wherein a plurality of the load sensors (1a, 1b, 2a, 2b) are arranged minor-symmetrically with respect to a first axis (210) and mirror-symmetrically with respect to a second axis (212),
wherein the first and the second axis (210, 212) are aligned orthogonally to one another, and
wherein at least some of the load sensors (1a, 1b, 2a, 2b) are in a grid arrangement in a common plane, wherein the grid arrangement has at least two load sensors (1a, 1b, 2a, 2b) on each side,
wherein the common plane is between the at least two parts of the operating table (100, 200); and
wherein the load sensors (1a, 1b, 2a, 2b) in the grid arrangement and the at least two parts of the operating table (100, 200) are all fastened substantially immovably with respect to one another.

6. The operating table (100, 200) according to claim 1, wherein the plurality of load sensors (1a, 1b, 2a, 2b) are arranged in a single common plane between the at least two parts of the operating table (100, 200).

7. The operating table (100, 200) according to claim 1, further comprising a load determination unit (104) which is coupled to the load sensor assembly (102) and uses the measured at least one variable to determine at least one of the following loads and/or one of the following centers of gravity:
a measurement load, which is the load acting on the load sensor assembly (102), and/or the center of gravity of the measurement load,
an active load, which is a load caused by people and components not associated with the operating table (100, 200) and external forces and acts on the operating table (100, 200), and/or the center of gravity of the active load, and
a total load, which results from the measurement load and from a load caused by components which are associated with the operating table (100, 200) and are located below the load sensor assembly (102), and/or the center of gravity of the total load.

8. The operating table (100, 200) according to claim 7, further comprising a safety unit (106) which is coupled to the load determination unit (104) and which, based on at least one of the loads determined by the load determination unit (104) and/or at least one of the centers of gravity determined by the load determination unit (104), generates a safety signal (126) which indicates whether the operating table (100, 200) is in a safety-critical state.

9. The operating table (100, 200) according to claim 8, configured wherein if the safety unit (106) generates the safety signal (126) such that it indicates a safety-critical state of the operating table (100, 200), an acoustic and/or visual warning signal and/or a warning signal is generated in text form and/or a movement of the operating table (100, 200) is slowed down or stopped and/or at least one functionality of the operating table (100, 200) is blocked.

10. The operating table (100, 200, 300) according to claim 8, wherein the safety unit (106) comprises a tipping prevention unit (114) which, based on the total load and/or the center of gravity of the total load, generates a tipping safety signal (128) which indicates whether there is a risk that the operating table (100, 200, 300) will tip over.

11. The operating table (100, 200, 300) according to claim 10, wherein the tipping prevention unit (114) determines a residual tipping torque for at least one tipping point (310) on the basis of the total load and/or the center of gravity of the total load, compares the residual tipping torque to a predetermined residual tipping torque threshold value, and generates the tipping safety signal (128) such that it indicates a risk of tipping if the residual tipping torque falls below the residual tipping torque threshold value.

12. The operating table (100, 200, 300) according to claim 10, wherein at least one virtual line (320, 322) is specified which extends through at least one tipping point (310) and which encloses a specified stability angle with a specified normal vector (324), wherein the tipping prevention unit (114) generates the tipping safety signal (128) such that it indicates a risk of tipping if the center of gravity of the total load extends through the at least one virtual line (320, 322).

13. The operating table (100, 200, 400) according to claim 8, wherein the safety unit (106) comprises an overload protection unit (116) which, based on a defined load, which is the measured load, the active load, or the total load, and/or the center of gravity of the defined load, generates an overload protection signal (130) which indicates whether there is a risk of overloading the operating table (100, 200, 400) and/or at least one component of the operating table (100, 200, 400).

14. The operating table (100, 200, 400) according to claim 13, wherein the overload protection unit (116) compares the defined load to at least one predetermined overload threshold value and generates the overload protection signal (130) such that it indicates a risk of overloading if the defined load exceeds the at least one overload threshold value, wherein the at least one overload threshold value is specific to the operating table (100, 200, 400) and/or the at least one component.

15. The operating table (100, 200, 400) according to claim 13, wherein the operating table has a patient support surface (18) having a main support surface section (408) and at least one secondary support surface section (402, 404, 406) detachably connected to the main support surface section (408), wherein the at least one component is the at least one secondary support surface section (402, 404, 406).

16. The operating table (100, 200, 400) according to claim 15, wherein the patient support surface (18) has multiple secondary support surface sections (402, 404, 406),
wherein an overload threshold value is specified for the configuration (410) in which the secondary support surface sections (402, 404, 406) are connected to each other and to the main support surface section (408), and
wherein the overload protection unit (116) compares the defined load to the overload threshold value specified for the configuration (410) of the secondary support surface sections (402, 404, 406) and generates the overload protection signal (130) such that it indicates a risk of overload if the defined load exceeds the overload threshold value.

17. The operating table (100, 200, 400) according to claim 15, wherein at least part of the patient support surface (18) is virtually divided into multiple areas and an overload threshold value is specified for each area, and
wherein the overload protection unit (116) checks the area in which the center of gravity of the defined load is located and compares the defined load to the overload threshold value specified for this area and generates the overload protection signal (130) such that it indicates a risk of overload if the defined load exceeds the overload threshold value specified for this area.

18. The operating table (100, 200, 400) according to claim 15, wherein a respective overload threshold value is specified for each point of at least part of the patient support surface (18), and
wherein the overload protection unit (116) checks the point of the patient support surface (18) at which the center of gravity of the defined load is located and compares the defined load to the overload threshold value specified for this point and generates the overload protection signal (130) such that it indicates a risk of overload if the defined load exceeds the overload threshold value specified for this point.

19. The operating table (100, 200, 400) according to claim 13, wherein the operating table (100, 200, 400) has at least one drive, and
wherein the overload protection unit (116) determines a load acting on the at least one drive on the basis of the measurement load and/or the center of gravity of the measurement load and compares the determined load to at least one specified overload threshold value and generates the overload protection signal (130) such that it indicates a risk of overloading if the determined load exceeds the at least one overload threshold value.

20. A method for operating an operating table (100, 200) according to claim 1, wherein the load sensor assembly (102) of the operating table (100, 200) measures at least one variable from which a load acting on the load sensor assembly (102) may be determined.
